(19) United States
(12) Patent Application Publication
(10) Pub. No.: US 2014/0247732 A1
(43) Pub. Date: Sep. 4, 2014

(54) ABSOLUTE GRANT CHANNEL FOR IRAT MEASUREMENT IN A HIGH SPEED DATA NETWORK

(71) Applicant: QUALCOMM INCORPORATED, San Diego, CA (US)

(72) Inventors: Ming Yang, San Diego, CA (US); Tom Chin, San Diego, CA (US)

(73) Assignee: QUALCOMM Incorporated, San Diego, CA (US)

(21) Appl. No.: 13/784,314

(22) Filed: Mar. 4, 2013

(51) Int. Cl. H04W 72/14

(52) U.S. Cl. CPC H04W 72/14
USPC 370/252

(57) ABSTRACT

A method for handling grants includes communicating with a first radio access technology (RAT). An uplink grant that corresponds to at least one uplink timeslot overlapping with a measurement signal from a second RAT is discarded. The discarding of the uplink grant is based at least in part on a signal quality of the first RAT. Measurement of the second RAT during the at least one uplink timeslot is performed.

### BACKGROUND

1. Field

Aspects of the present disclosure relate generally to wireless communication systems, and more particularly, to grant handling for inter-RAT measurement in a high speed TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes communicating with a first radio access technology (RAT). An uplink grant that corresponds to at least one uplink timeslot overlapping with a measurement signal from a second RAT is discarded. The discarding of the uplink grant is based at least in part on a signal quality of the first RAT. Measurement of the second RAT during the at least one uplink timeslot is performed.

Another aspect discloses an apparatus for wireless communication having a memory and at least one processor coupled to the memory. The processor(s) is configured to communicate with a first radio access technology (RAT). The processor(s) is also configured to discard an uplink grant that corresponds to at least one uplink timeslot overlapping with a measurement signal from a second RAT. The discarding of the uplink grant is based at least in part on a signal quality of the first RAT. The processor(s) is also configured to perform measurement of the second RAT during the at least one uplink timeslot.

In another aspect an apparatus is disclosed that includes means for communicating with a first radio access technology (RAT). The apparatus also includes means for discarding an uplink grant that corresponds to at least one uplink timeslot overlapping with a measurement signal from a second RAT. The discarding of the uplink grant is based at least in part on a signal quality of the first RAT. The apparatus also includes means for performing measurement of the second RAT during the at least one uplink timeslot.

Another aspect discloses a computer program product for wireless communications in a wireless network having a non-transitory computer-readable medium. The computer readable medium has non-transitory program code recorded thereon which, when executed by the processor(s), causes the processor(s) to perform operations of communicating with a first radio access technology (RAT). The processor(s) is also configured to discard an uplink grant that corresponds to at least one uplink timeslot overlapping with a measurement signal from a second RAT. The discarding of the uplink grant is based at least in part on a signal quality of the first RAT. The processor(s) is also configured to perform measurement of the second RAT during the at least one uplink timeslot.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a GSM frame cycle.

FIG. 6 is a call flow diagram illustrating grant discarding according to one aspect of the present disclosure.

FIG. 7 is a block diagram illustrating a method for discarding uplink grants to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

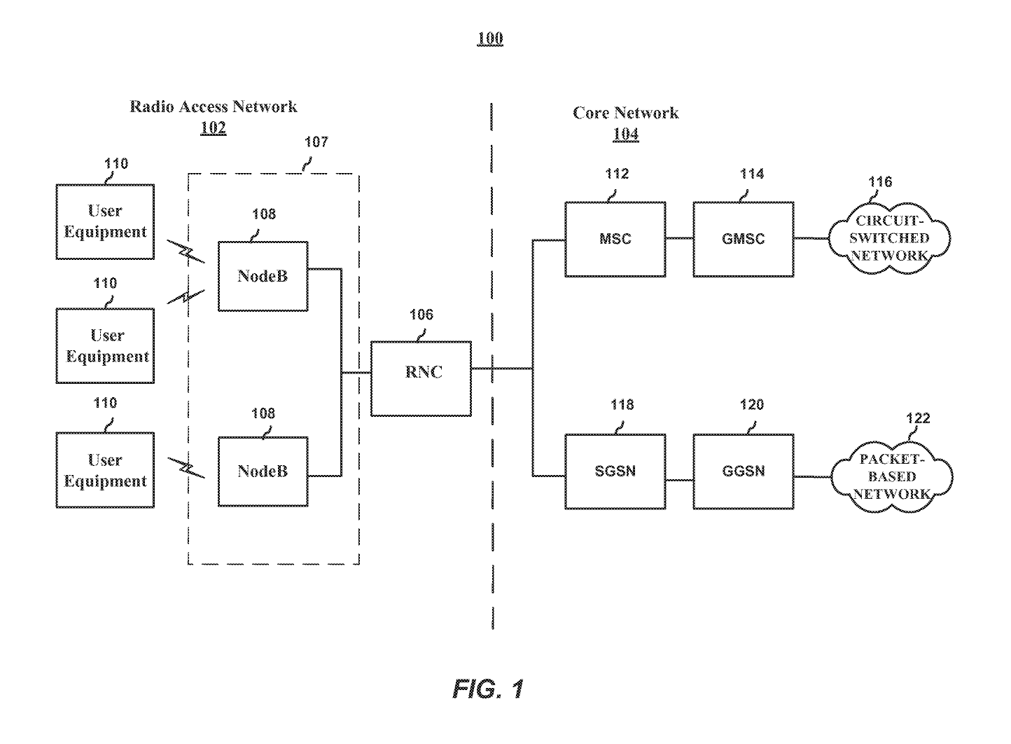

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

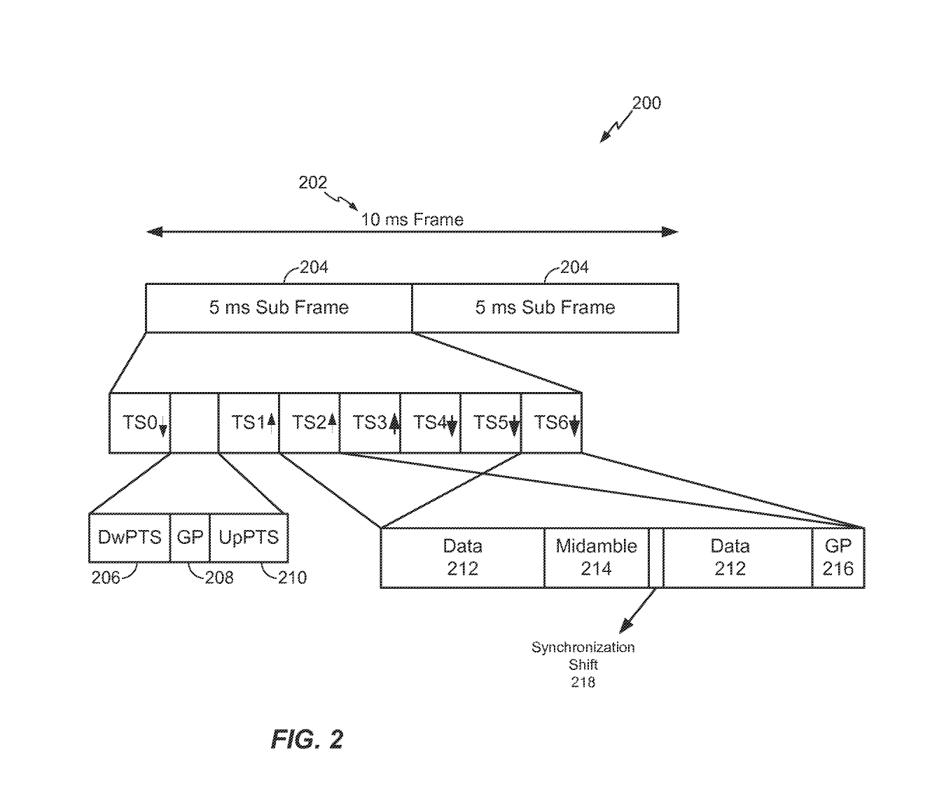

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

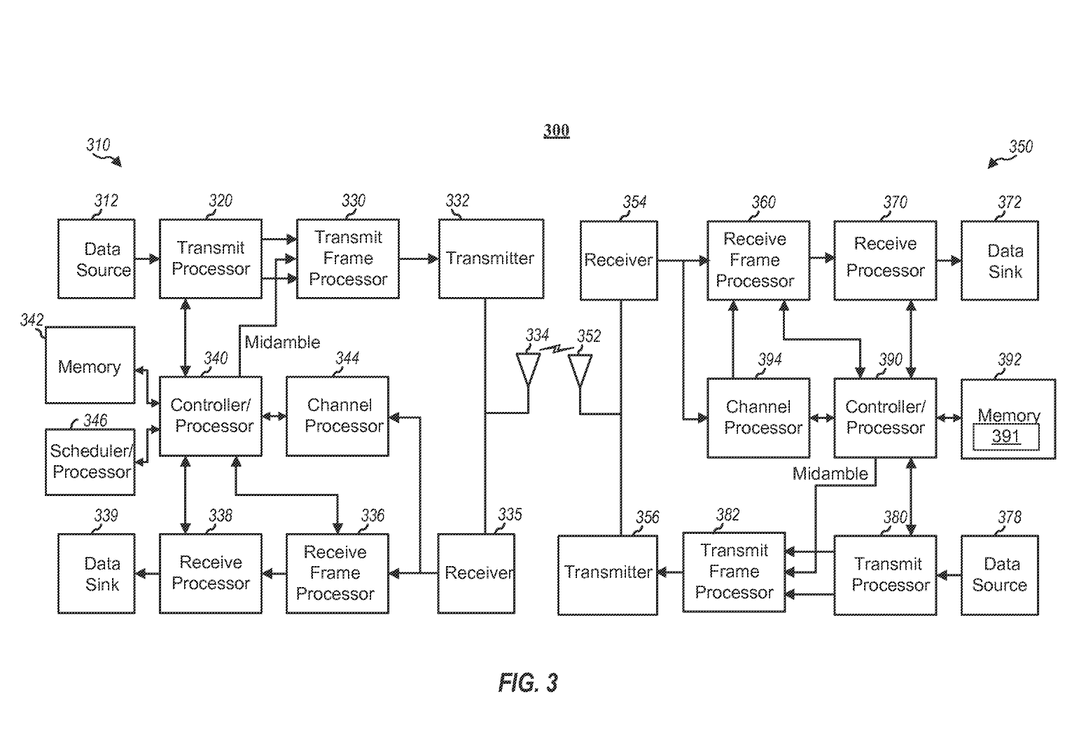

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an uplink grant management module 391 which, when executed by the controller/processor 390, configures the UE 350 for discarding uplink grants under certain conditions. A scheduler/processor 346 at the node B 310 may be used to allocate resources to the UEs and schedule downlink and/or uplink transmissions for the UEs.

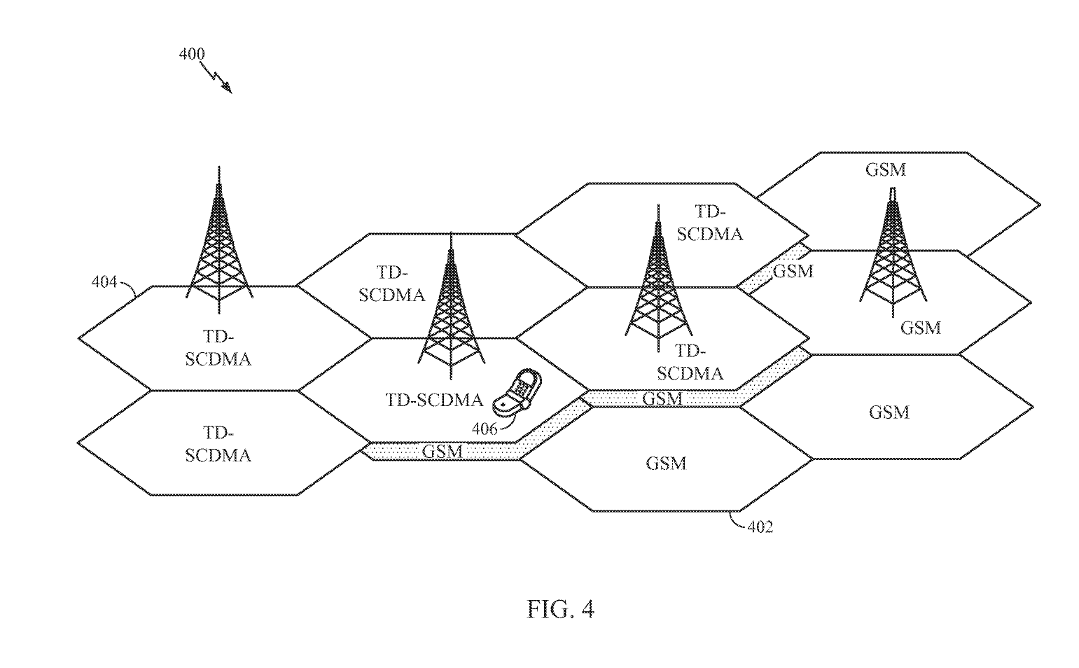

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

During the handover process the UE tunes to the GSM channel to acquire information from the GSM network. Because the available TD-SCDMA continuous time slots are limited (for example, only two or three continuous timeslots are typically available in a radio frame), the UE has limited time to measure the GSM cells and cannot complete a full measurement during a single set of continuous time slots. Thus, a portion of the measurement occurs during the first set of continuous time slots, a further portion of the measurement occurs during the available set of continuous time slots in the next cycle, etc., until enough time was provided to complete the measurement. Consequently, a slower than desired TD-SCDMA to GSM handover occurs.

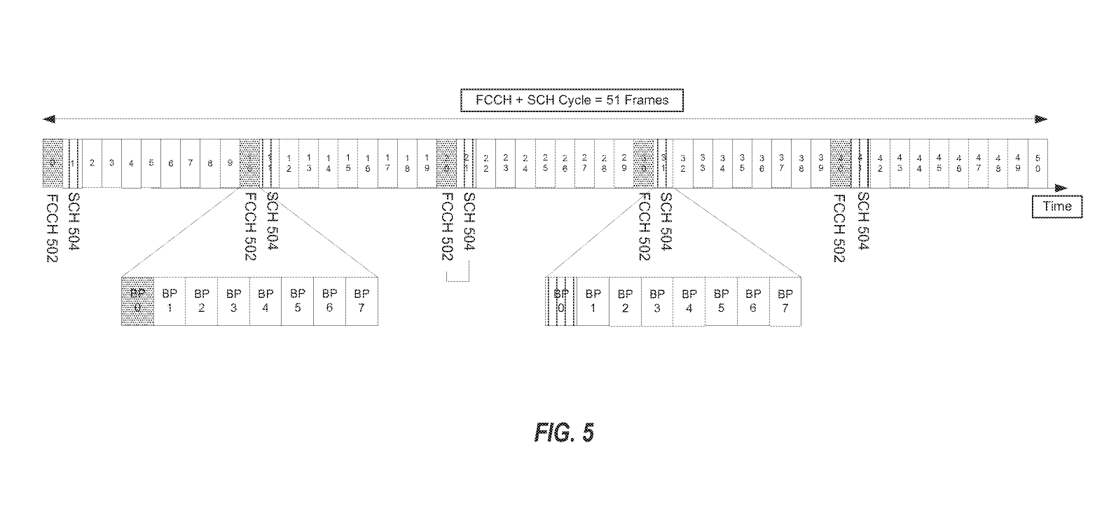

FIG. 5 is a block diagram illustrating a GSM frame cycle. The GSM frame cycle for the frequency correction channel (FCCH) 502 and synchronization channel (SCH) 504 consists of 51 frames, each of 8 burst periods (BPs). The FCCH 502 is in the first burst period (or BP 0) of frame 0, 10, 20, 30, 40, and the SCH 504 is in the first burst period of frame 1, 11, 21, 31, 41. A single burst period is 15/26 ms and a single frame is 120/26 ms. As shown in FIG. 5, the FCCH period is 10 frames (46.15 ms) or 11 frames (51.77 ms). Also as shown, the SCH period is 10 frames or 11 frames.

### Handling Enhanced Absolute Grant Channel Grants

High speed uplink packet access (HSUPA) is an enhancement to TD-SCDMA, and is utilized to enhance uplink throughput. HSUPA introduces the following physical channels: enhanced uplink dedicated channel (E-DCH), E-DCH physical uplink channel (E-PUCH), E-DCH uplink control channel (E-UCCH), E-DCH random access uplink control channel (E-RUCCH), absolute grant channel for E-DCH and hybrid ARQ indication channel for E-DCH.

The E-DCH is a dedicated transport channel and may be utilized to enhance an existing dedicated channel (DCH) transport channel carrying data traffic. The E-PUCH carries E-DCH traffic and scheduling information (SI). The E-PUCH can be transmitted in burst fashion.

The E-UCCH carries Layer 1 information for E-DCH. The E-UCCH includes the uplink physical control channel and carries scheduling information (SI), including a scheduling request and the UE ID (i.e., enhanced radio network temporary identifier (E-RNTI).) The transport block size may be 6 bits and the retransmission sequence number (RSN) may be 2 bits. Also, the HARQ process ID may be 2 bits.

The E-RUCCH is an uplink physical control channel that carries scheduling information and enhanced radio network temporary identities ((E-RNTI) used for identifying the UEs. The E-AGCH carries grants for E-PUCH transmission, such as the maximum allowable E-PUCH transmission power, time slots, and code channels. Additionally, the E-HICH carries HARQ ACK/NAK signals.

The HARQ processes enable a UE and node B to confirm proper receipt of communications. For example, after a UE sends a high speed uplink packet to a node B, the UE will receive (typically 2 subframes later) the ACK/NAK message from the node B indicating whether the received packet was properly decoded by the node B. A NAK message (indicating unsuccessful decoding) may result in the UE resending the packet in question. A number of parallel HARQ processes (identified by a HARQ process identifier) are used in the UE to support the HARQ entity, allowing transmissions to take place continuously while the UE is granted resources. The HARQ entity identifies the HARQ process for which transmission will take place if resources are available through the grant. Also, based on timing with respect to a previously-transmitted media access control entity (MAC-e) protocol data unit (PDU), the UE may route the receiver feedback (ACK/NACK information), relayed by the physical layer, to the appropriate HARQ process. The HARQ entity is responsible for determining which HARQ process will use the assigned resources in a given transmit time interval (TTI). The HARQ entity is further responsible for determining for each HARQ process whether new data or existing data should be transmitted from the HARQ process buffer.

During high speed operations, when a UE receives a E-AGCH grant consecutively every subframe, due to the HARQ processes and uplink activity, the UE may not have sufficient idle slots to perform inter-RAT (IRAT) operations to assist in cell reselection or handover procedures. The IRAT operations may include, for example, detecting a GSM RSSI or frequency correction channel (FCCH), synchronization channel (SCH) BSIC confirmation and reconfirmation procedures, etc. As a result, a UE may not be able to perform IRAT measurements until a call is dropped, even if there may be strong alternate RAT(s), such as a neighboring GSM cell, available for handover.

One aspect of the present disclosure is directed to providing the UE sufficient time slots to perform IRAT measurement. When the TD-SCDMA coverage/signal strength begins to weaken, the UE may discard high speed uplink grants and use the granted timeslot for IRAT measurement. Specifically, a UE may perform measurements when TD-SCDMA serving node B has a received signal code power (RSCP) for a pilot channel (e.g., primary common control physical channel (P-CCPCH) below a threshold. Alternatively, the UE may measure if a downlink (DL) traffic time slot experiences a signal-to-noise ratio (SNR) or signal-to-interference plus noise ratio (SINR) is above a certain threshold. In another aspect, the UE may measure if its uplink transmit power is above a certain threshold. Other examples for potential signal strength measurements include a received signal strength indication (RSSI). If any of these mentioned measurements are below/above their respective thresholds and the UE receives E-AGCH grants consecutively for new transmissions every subframe the UE may discard those E-AGCH grants.

If a grant is discarded, the UE does not transmit E-PUCH data on the time slots allocated within the discarded grant. The UE also may not monitor the E-HICH downlink timeslots related to the discarded E-PUCH transmission. The UE may also discard any HARQ allocated time slots that may have been used to communicate ACK/NACK messages for the uplink slots granted in the discarded grant. As the UE will not be sending any data to a node B during these time slots (and instead will be using them for IRAT measurement) the UE may similarly disregard the time slots for those associated ACK/NACK messages. The discarded time slots are considered idle for the UE to then allocate to IRAT measurement communications. The UE may thus avoid call drops that may result from limited IRAT measurement due to full E-AGCH scheduling.

The number of discarded grants may be a function of how far below/above the measurements are with respect to their respective thresholds. For example, if a signal is very poor, more grants may be discarded, thus allowing more time for IRAT measurements. In one aspect, grants may be discarded randomly. A certain number (m) grants may be discarded out of the total number of grants (n). For example, out of the total number of grants, the UE may discard three or four such grants. In another aspect, the UE may determine when the GSM signal will be broadcasting a synchronization channel (SCH) transmission, such as SCH transmission 504 illustrated in FIG. 5. The UE may then discard an uplink grant that would correspondingly lead to a gap which overlaps with the UE receiving the SCH transmission. The UE may determine not to discard grants if there is data waiting in the UE buffer or if a particular uplink transmission is for a re-transmission of a packet due to HARQ scheduling.

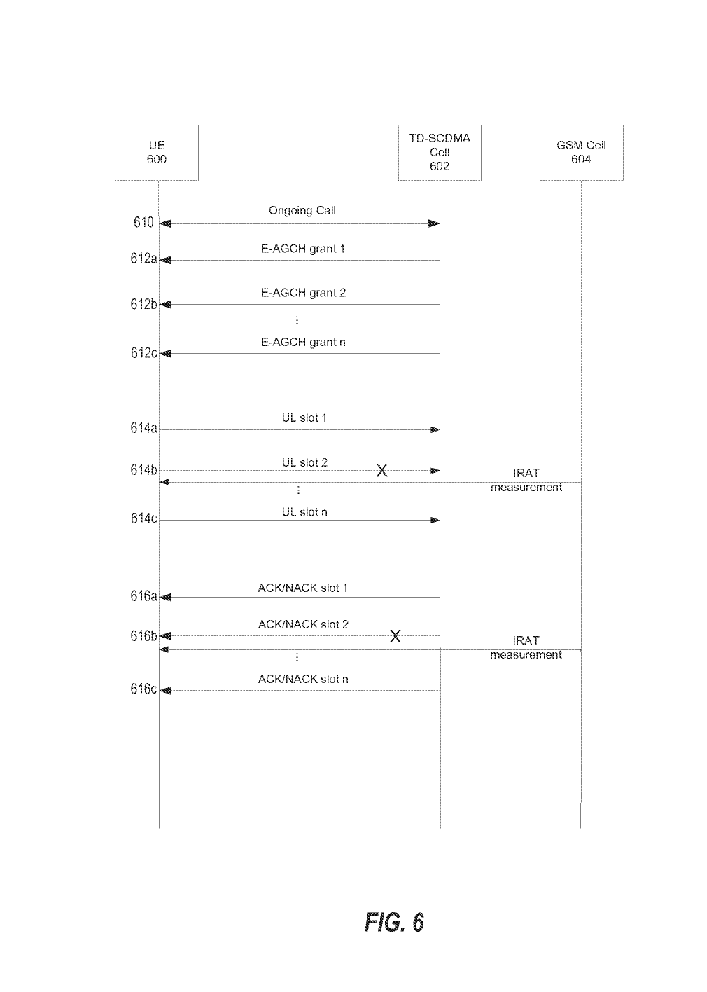

FIG. 6 illustrates a call flow according to one aspect of the present disclosure. A UE 600 is engaged in an ongoing call 610 with a TD-SCDMA cell 602. As part of the call, the TD-SCDMA cell 602 continually sends the UE 600 E-AGCH grants as illustrated by a first grant 612a, a second grant 612b and an nth grant (n) 612n. As illustrated, the first grant 612a corresponds with an uplink (UL) slot 614a and ACK/NACK slot 616a. The grant 612b corresponds to the uplink slot 614b and ACK/NACK slot 616b. The grant n 612n corresponds to the uplink slot 614n and ACK/NACK slot 614n. Other grants/slots may also be possible but are not illustrated. If, during its TD-SCDMA communications, the UE determines that the TD-SCDMA connection is weak enough to potentially handover to another RAT, the UE may discard one or more E-AGCH grants to allocate time slots for IRAT measurement(s). In the example illustrated in FIG. 6, the UE discards the second grant (grant 2) 612b, thereby allowing IRAT measurement to occur during the uplink slot 614b and ACK/NACK slot 616b.

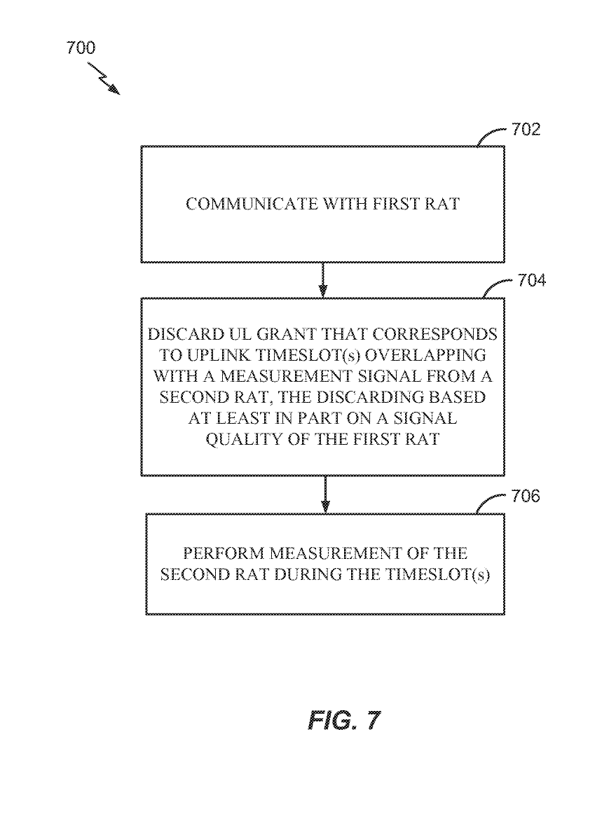

FIG. 7 shows a wireless communication method 700 according to one aspect of the disclosure. A UE communicates with a first radio technology (RAT), as shown in block 702. In block 704, the UE discards an uplink grant that corresponds to at least one uplink timeslot overlapping with a measurement signal from a second RAT. The discarding of the uplink grant is also based at least in part on a signal quality of the first RAT. In block 706, the UE performs measurement of the second RAT during the at least one uplink timeslot.

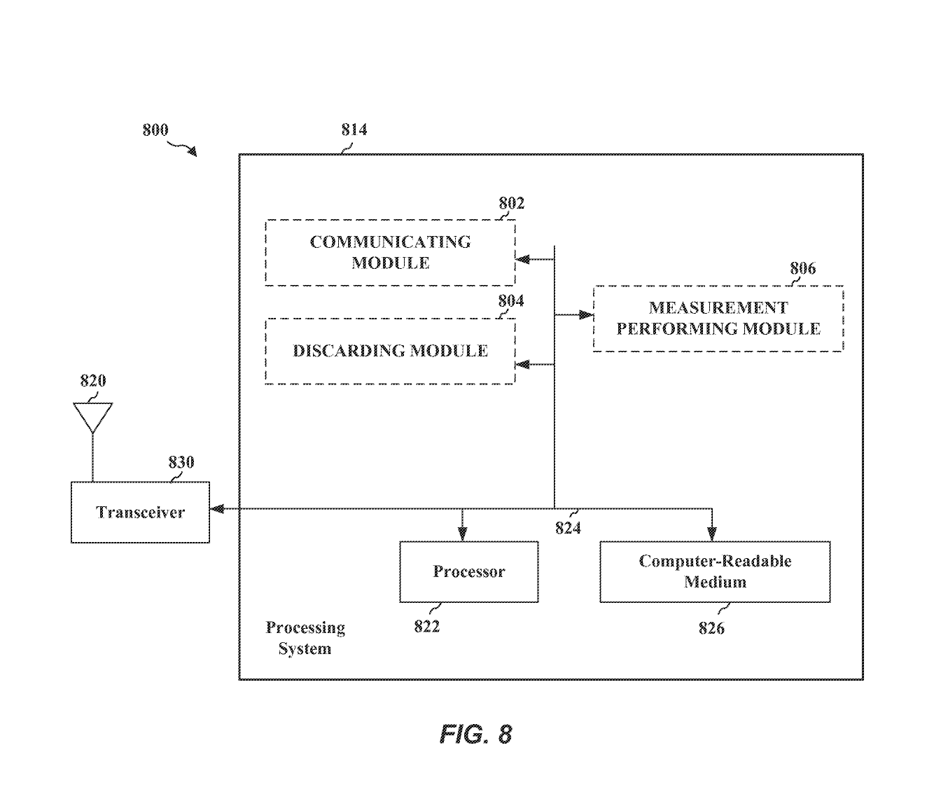

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804, 806 and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a communicating module 802 for communicating with a first RAT. The processing system 814 includes a discarding module 804 for discarding an uplink grant that corresponds to at least one uplink timeslot overlapping with a measurement signal from a second RAT, the discarding of the uplink grant based at least in part on a signal quality of the first RAT. The processing system 814 also includes a measurement performing module 806 for performing measurement of the second RAT during the at least one uplink timeslot. The modules may be software modules running in the processor 822, resident/stored in the computer readable medium 826, one or more hardware modules coupled to the processor 822, or some combination thereof The processing system 814 may be a component of the UE 350 and may include the memory 392, and/or the controller/processor 390.

In one configuration, an apparatus such as a UE 350 is configured for wireless communication including means for communicating. In one aspect, the communicating means may be the antennas 352, the receivers 354, the receive processor 370, the controller/processor 390, the memory 392, the transmit processor 380 and/or the transmitters 356 configured to perform the functions recited by the communicating means. The UE 350 is also configured to include a means for discarding. In one aspect, the discarding means may be the controller/processor 390, and the memory 392 configured to perform the functions recited by the discarding means. The UE 350 is also configured to include means for performing a measurement. In one aspect, the measurement performing means the controller/processor 390, and/or the memory 392 configured to perform the functions recited by the performing measurement means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
communicating with a first radio access technology (RAT);
discarding an uplink grant that corresponds to at least one uplink timeslot overlapping with a measurement signal from a second RAT, the discarding based at least in part on a signal quality of the first RAT; and
performing measurement of the second RAT during the at least one uplink timeslot.

2. The method of claim 1, in which the measurement signal from the second RAT is a synchronization channel (SCH) communication from a Global System for Mobile Communications (GSM) RAT.

3. The method of claim 1, further comprising measuring the signal quality of the first RAT over a certain time period prior to discarding the uplink grant.

4. The method of claim 1, further comprising discarding an uplink grant based at least in part on a number of uplink timeslots corresponding to the uplink grant.

5. The method of claim 1, in which the signal quality of the first RAT is below a threshold, which comprises the signal quality of the first RAT being below the threshold for a certain time period.

6. The method of claim 1, in which performing measurement of the second RAT comprises measuring one of a received signal code power (RSCP), received signal strength indication (RSSI) measurement, frequency correction channel (FCCH) tone detection, or synchronization channel (SCH) base station identity code (BSIC) verification.

7. The method of claim 1, further comprising performing measurement of the second RAT during an acknowledgement/negative acknowledgment (ACK/NACK) downlink timeslot corresponding to the discarded uplink grant.

8. The method of claim 1, further comprising determining a number of uplink grants to discard based at least in part on a signal quality of the first RAT.

9. The method of claim 1, further comprising determining whether the uplink grant corresponds to a new transmission or retransmission and discarding the uplink grant when the uplink grant corresponds to a new transmission.

10. The method of claim 1, further comprising determining the signal quality of the first RAT based at least in part on one of:
comparing a primary common control physical channel (P-CCPCH) received signal code power (RSCP) to a threshold;
comparing a downlink traffic time slot signal to noise ratio (SNR) or signal to interference plus noise ratio (SINR) to a threshold; and
comparing a transmission power to a threshold.

11. The method of claim 1, in which the grant is a high speed uplink packet access (HSUPA) grant.

12. An apparatus for wireless communication, comprising:
a memory; and
at least one processor coupled to the memory, the at least one processor being configured:
to communicate with a first radio access technology (RAT);
to discard an uplink grant that corresponds to at least one uplink timeslot overlapping with a measurement signal from a second RAT, the discarding based at least in part on a signal quality of the first RAT; and
to perform measurement of the second RAT during the at least one uplink timeslot.

13. The apparatus of claim 12, in which the measurement signal from the second RAT is a synchronization channel (SCH) communication from a Global System for Mobile Communications (GSM) RAT.

14. The apparatus of claim 12, in which the at least one processor is further configured to measure the signal quality of the first RAT over a certain time period prior to discarding the uplink grant.

15. The apparatus of claim 12, in which the at least one processor is further configured to discard an uplink grant based at least in part on a number of uplink timeslots corresponding to the uplink grant.

16. The apparatus of claim 12, in which the signal quality of the first RAT is below a threshold, which comprises the signal quality of the first RAT being below the threshold for a certain time period.

17. The apparatus of claim 12, in which the at least one processor configured to perform measurement of the second RAT is further configured to measure one of a received signal code power (RSCP), received signal strength indication (RSSI) measurement, frequency correction channel (FCCH) tone detection, or synchronization channel (SCH) base station identity code (BSIC) verification.

18. The apparatus of claim 12, in which the at least one processor is further configured to perform measurement of the second RAT during an acknowledgement/negative acknowledgment (ACK/NACK) downlink timeslot corresponding to the discarded uplink grant.

19. The apparatus of claim 12, in which the at least one processor is further configured to determine a number of uplink grants to discard based at least in part on a signal quality of the first RAT.

20. The apparatus of claim 12, in which the at least one processor is further configured to determine whether the uplink grant corresponds to a new transmission or retransmission and to discard the uplink grant when the uplink grant corresponds to a new transmission.

21. The apparatus of claim 12, in which the at least one processor is further configured to determine the signal quality of the first RAT based at least in part on one of:
comparing a primary common control physical channel (P-CCPCH) received signal code power (RSCP) to a threshold;
comparing a downlink traffic time slot signal to noise ratio (SNR) or signal to interference plus noise ratio (SINR) to a threshold; and
comparing a transmission power to a threshold.

22. The apparatus of claim 12, in which the grant is a high speed uplink packet access (HSUPA) grant.

23. An apparatus for wireless communication, comprising:
means for communicating with a first radio access technology (RAT);
means for discarding an uplink grant that corresponds to at least one uplink timeslot overlapping with a measurement signal from a second RAT, the discarding based at least in part on a signal quality of the first RAT; and
means for performing measurement of the second RAT during the at least one uplink timeslot.

24. A computer program product for wireless communication in a wireless network, comprising:
a non-transitory computer-readable medium having non-transitory program code recorded thereon, the program code comprising:
program code to communicate with a first radio access technology (RAT);
program code to discard an uplink grant that corresponds to at least one uplink timeslot overlapping with a measurement signal from a second RAT, the discarding based at least in part on a signal quality of the first RAT; and
program code to perform measurement of the second RAT during the at least one uplink timeslot.
